(19) United States
(12) Patent Application Publication
(10) Pub. No.: US 2026/0338372 A1
(43) Pub. Date: Oct. 29, 2026

(54) NUCLEAR PLANT STEAM GENERATOR

(71) Applicant: Rolls-Royce SMR Limited, Derby Derbyshire (GB)

(72) Inventors: Daniel Topala, Derby Derbyshire (GB); Thomas James Peacock, Derby Derbyshire (GB); Jordan Alexander Shapland, Derby Derbyshire (GB); Juilian George George Robson Emslie, Derby Derbyshire (GB)

(21) Appl. No.: 19/124,206

(22) PCT Filed: Oct. 23, 2023
(86) PCT No.: PCT/EP2023/079495

§ 371 Date: Apr. 24, 2025

(30) Foreign Application Priority Data
Oct. 31, 2022 (GB) 2216157.4

(51) Int. Cl. F22B 37/00; F22B 37/24; G21D 1/00; G21D 1/04

(52) U.S. Cl. CPC F22B 37/007; F22B 37/248; G21D 1/006; G21D 1/04

(57) ABSTRACT

A nuclear plant steam generator is provided. The steam generator has an upright elongate body and has tension members extending from proximal ends attaching to respective attachment positions on the elongate body to distal ends which are configured to attach to respective load-supporting attachment positions in the nuclear plant. Each proximal end is lower than its respective distal end. In use, the tension members are loaded in tension by the steam generator to transmit substantially all of the weight of the steam generator to the load-supporting attachment positions in the nuclear plant.

### FIELD OF THE INVENTION

The present invention relates to a nuclear plant steam generator.

### BACKGROUND

Nuclear power plants convert heat energy from the nuclear decay of fissile material contained in fuel assemblies within a reactor core into electrical energy. Pressurised water reactor (PWR) plants have a primary coolant circuit which typically connects the following pressurised components: a reactor pressure vessel (RPV) containing the fuel assemblies; one or more steam generators; and a pressuriser. Coolant pumps in the primary circuit circulate pressurised water through pipework between these components. The RPV houses the nuclear core which heats the water in the primary circuit. The steam generator functions as a heat exchanger between the primary circuit and a secondary system.

FIG. 1 is a schematic diagram of a PWR 20. An RPV 22 containing fuel assemblies is centrally located in the reactor. Clustered around the RPV are three steam generators 24 connected to the RPV by pipework 26 of the pressurised water primary coolant circuit 32. A pressuriser 28 maintains the water pressure in the primary coolant circuit. Coolant pumps 30 suspended beneath the steam generators circulate pressurised water around the primary coolant circuit, taking heated water from the RPV to the steam generators, and cooled water from the steam generators to the RPV. In the steam generators, heat is transferred from the pressurised water to feed water circulating in pipework of a secondary coolant circuit 26, thereby producing steam which is used to drive turbines which in turn drive an electricity-generator. The steam is then condensed before returning to the steam generators.

Conventionally, high capital costs are associated with the construction and operation of large PWR plants, which typically have power outputs significantly in excess of 1 GWₑ. Due to these high capital costs, and a desire to service small electricity grids, the industry is moving towards the development of smaller units. Small modular reactors (SMRs) are reactors having power outputs of less than about 700 MWₑ. SMRs are seen as much more manageable investments than larger reactors. This is because SMRs benefit from economies of series production, relatively short construction times, and remote factory-based prefabrication before transportation of reactor elements to site.

Steam generators are conventionally supported by vertical supports loaded in compression, for example legs or columns extending from the base of a steam generator to the floor of the nuclear plant. However, these supports may not adequately accommodate displacement of the system associated with thermal expansion effects, and can thus lead to stresses being induced on interfacing pipework. Also, the supports for a given steam generator may be located adjacent to its coolant pump, and thus a concern arises that a catastrophic (albeit unlikely) failure of the coolant pump which produces a high energy missile could compromise the ability of the supports to carry the weight of the steam generator.

The present invention has been devised in light of the above considerations.

### SUMMARY OF THE INVENTION

In a first aspect, the present disclosure provides a nuclear plant steam generator, wherein the steam generator has an upright elongate body and has tension members extending from proximal ends attaching to respective attachment positions on the elongate body to distal ends which are configured to attach to respective load-supporting attachment positions in the nuclear plant, each proximal end being lower than its respective distal end whereby, in use, the tension members are loaded in tension by the steam generator to transmit substantially all of the weight of the steam generator to the load-supporting attachment positions in the nuclear plant.

The plural tension members provide redundancy in the unlikely event of failure of an individual tension member. They also increase the available space beneath the steam generator for other equipment, such as a coolant pump. Because the proximal ends of the tension members are lower than their distal ends, the tension members naturally extend upwards and away from the body of the steam generator. This distances the tension members from any equipment (e.g. a coolant pump) located beneath the steam generator, and thus reduces a risk that the ability of the members to support the steam generator may be compromised in case of failure of such equipment. Conveniently, the attachment positions of the tension members on the elongate body can be located on the side flanks of the body between its upper and lower ends.

The tension members can be readily adapted to accommodate displacement of the system associated with thermal expansion effects. For example, each of the tension members may have articulatable connections at its proximal and distal ends which attach the member to its respective attachment position on the elongate body and its load-supporting attachment position in the nuclear plant, the articulatable connections being configured to allow the steam generator to move relative to the load-supporting attachment position in the nuclear plant to accommodate lateral movement or vibration of the steam generator relative to the nuclear plant. In this way, stress-inducing strains in interfacing pipework to the steam generator can be reduced. Conveniently, each of the articulatable connections may be a pin-jointed connection.

Typically, the tension members may be equally angularly spaced in a circumferential row around the elongate body. For example, the steam generator may be supported by four tension members spaced 90° apart.

Typically, the steam generator may have a reactor coolant pump suspended beneath the elongate body, the weight of the reactor coolant pump being transmitted to the load-supporting attachment positions in the nuclear plant via the elongate body and the tension members.

The stream generator may have lateral restraints configured to limit or prevent sideways movement of the steam generator. The lateral restraints can help to maintain the structural integrity of the steam generator when subject to external forces produced by, for example, seismic activity. The lateral restraints may be located above the tension members. They may be equally angularly spaced in a circumferential row around the elongate body. For example, the steam generator may have four lateral restraints spaced 90° apart.

In a second aspect, the present disclosure provides a combination of a transport frame and the steam generator of the previous aspect mounted in the transport frame, wherein the transport frame is configured for transporting the steam generator to a site of a nuclear plant, and wherein the distal ends of the tension members attach to respective load-supporting attachment positions in the transport frame, the tension members being loaded in tension by the steam generator to transmit weight of the steam generator (and preferably transmit substantially all of the weight of the steam generator) to the load-supporting attachment positions. The transport frame provides structural support to the steam generator during transportation, typically between an off-site factory environment and the nuclear plant. Moreover, attaching the steam generator to the transport frame via the tension members enhances the ability to fabricate the steam generator in the off-site factory environment.

Typically, the transportation frame may be a steel frame.

In a third aspect, the present disclosure provides a nuclear plant including the nuclear plant steam generator of the first aspect, the distal ends of the tension members attaching to respective load-supporting attachment positions in the nuclear plant, such that the tension members are loaded in tension by the steam generator to transmit substantially all of the weight of the steam generator to the load-supporting attachment positions in the nuclear plant.

In a fourth aspect, the present disclosure provides a nuclear plant including the combination of the transport frame and the steam generator of the second aspect, the transport frame being a first transport frame and integrating with further transport frames in the nuclear plant to which are mounted other components of the nuclear plant, the first and further transport frames thereby forming a permanent part of the nuclear plant, and the distal ends of the tension members attaching to the respective load-supporting attachment positions of the first transport frame, such that the tension members are loaded in tension by the steam generator to transmit substantially all of the weight of the steam generator to the load-supporting attachment positions of the first transport frame. This double use of the transport frame for both transportation and final installation reduces nuclear plant construction costs and enhances plant modularity.

In a fifth aspect, the present disclosure provides a method of constructing a nuclear plant, the method comprising:
providing the combination of the transport frame and the steam generator of the second aspect;
transporting the combination of the transport frame and the steam generator to the site of a nuclear plant; and
installing the combination of the transport frame and the steam generator in the nuclear plant, the transport frame being a first transport frame and integrating with further transport frames in the nuclear plant to which are mounted other components of the nuclear plant, whereby the first and further transport frames form a permanent part of the nuclear plant, and the distal ends of the tension members attach to the respective load-supporting attachment positions of the first transport frame, such that the tension members are loaded in tension by the steam generator to transmit substantially all of the weight of the steam generator to the load-supporting attachment positions of the first transport frame.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 shows a schematic diagram of a pressurised water reactor;

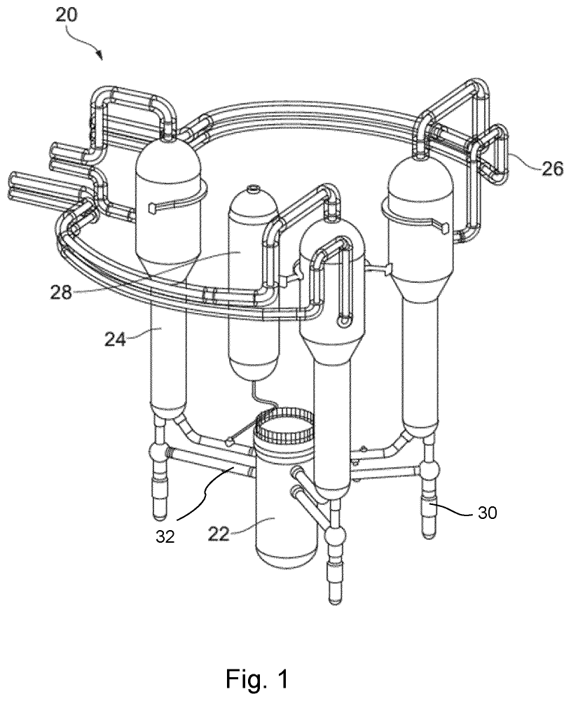

FIG. 2 shows a side view of a bottom portion of a steam generator for a nuclear plant and a coolant pump suspended beneath the steam generator;

FIG. 3 shows schematically a perspective view of the steam generator mounted in a transport frame; and

FIG. 4 shows schematically a perspective view of an arrangement of transport frames on a containment structure base mat of a nuclear plant.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

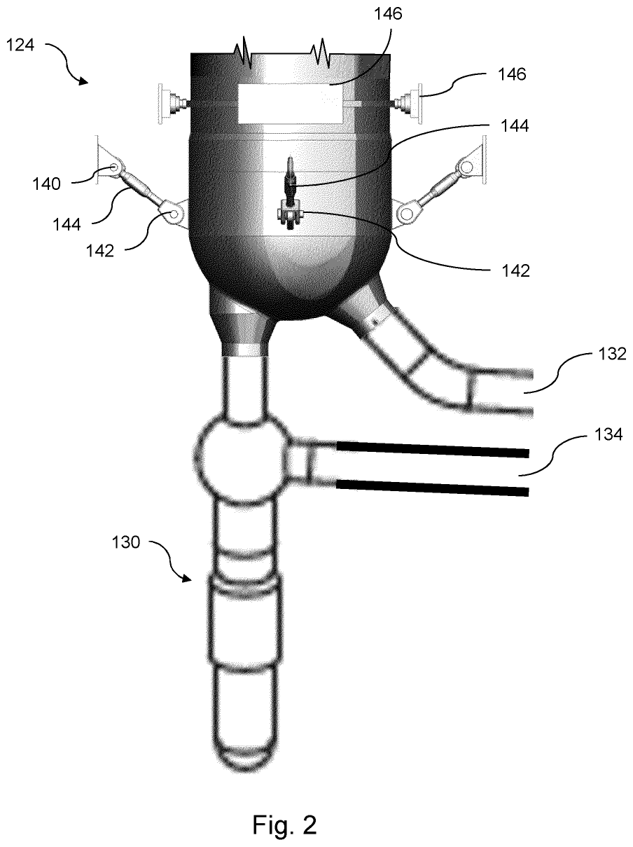

FIG. 2 shows a side view of a bottom portion of the upright elongate body of a steam generator 124 for a nuclear plant. The steam generator receives pressurised and heated water through inflow pipework 132 of a primary coolant circuit from a reactor vessel of the plant. Within the steam generator, heat is extracted from the water to produce steam in a secondary coolant circuit (not shown) for use in driving electricity generator turbines. The water from the primary coolant circuit leaves the steam generator through outflow pipework 134. A coolant pump 130 on the outflow pipework 134 and suspended beneath the steam generator circulates the water around the primary coolant circuit.

The steam generator 124 is supported in the nuclear plant by tension members 144 which extend outwards and upwards from proximal ends attaching to respective attachment positions on the elongate body of the steam generator to distal ends which attach to respective load-supporting attachment positions in the nuclear plant. The tension members are loaded in tension by the steam generator to transmit substantially all of the weight of the steam generator and the suspended coolant pump 130 to the load-supporting attachment positions.

The attachments at both ends of each tension member 144 are made by articulatable pin-jointed connectors. More particularly, the proximal end has an inner pin-jointed connector 142, and the distal end has an outer pin-jointed connector 140. These connectors have enough play to allow the steam generator 124 to move relative to the load-supporting attachment positions in the nuclear plant. In this way, lateral movement of the steam generator relative to the nuclear plant can be accommodated, which in turn reduces or avoids the production of stress-inducing strains in the interfacing pipework of both the primary and secondary coolant circuits.

By supporting the steam generator via the tension members 144, more space is made available under the generator for the coolant pump 130 compared to that made available by conventional, underside, compressively loaded vertical supports. Moreover, the increased distance between the tension members and the coolant pump reduces the risk that a high energy missile produced by a catastrophic failure of the coolant pump could compromise the ability of the tension members to support the steam generator. The plural tension members also provide redundancy in the unlikely event of failure of an individual tension member.

In this specific example of FIG. 2, the steam generator 124 has four tension members 144 equally angularly spaced 90° apart in a circumferential row around its elongate body.

The steam generator 124 also has four lateral restraints 146. The restraints are spaced 90° apart and are located above respective tension members 144. The lateral restraints limit the total sideways movement of the steam generator by providing physical blocks to lateral movement. The stops comprise a combination of guides and snubbers that locate between the steam generator and respective restraint positions in the nuclear plant. They permit lateral movement of the steam generator (up to a limit defined by the adjustable stops) during normal operation to account for expansion/contraction of the pipework of the primary coolant circuit, and also help to maintain the structural integrity of the steam generator when subject to external forces produced by, for example, by a seismic event.

The number and position of both the tension members 144 and the lateral restraints 146 may be varied depending on the requirements of a given nuclear plant.

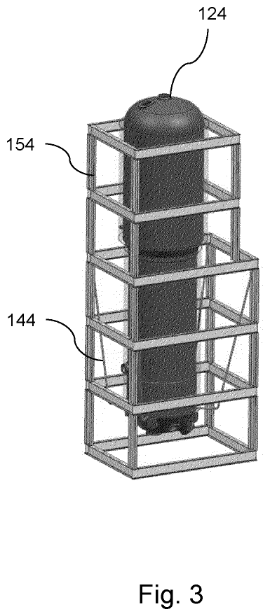

FIG. 3 shows schematically a perspective view of the steam generator 124 mounted in a transport frame 154. More particularly, the steam generator is supported within the transport frame by the four tension members 144. The transport frame, which is typically an open lattice steel frame, provides structural support to the steam generator both during transportation to site and during operation as part of the nuclear plant when the frame is integrated into the plant. Thus, the distal ends of the tension members attach to positions in the transport frame, which positions become the permanent load-supporting attachment positions for the members in the nuclear plant. In use, as mentioned above, the tension members transmit substantially all of the weight of the steam generator to the load-supporting attachment positions. However, during transportation, additional supports and/or packing bodies may be provided to hold the steam generator securely in the frame.

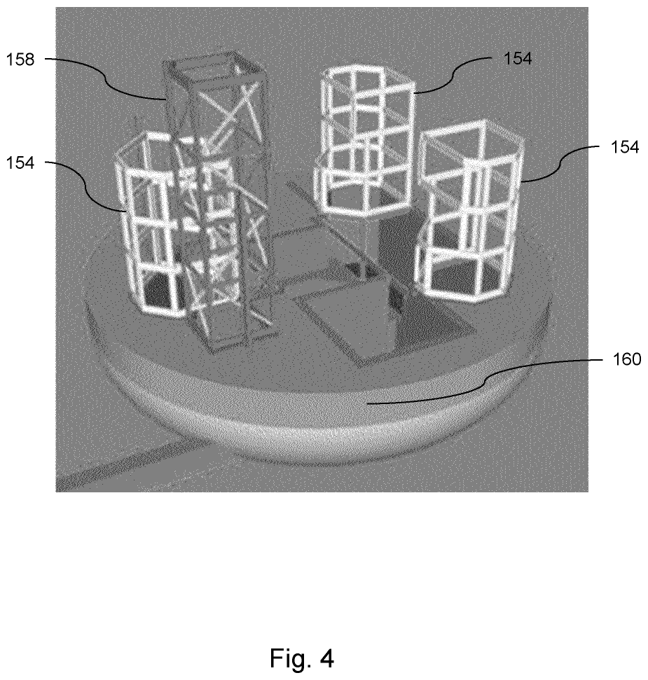

FIG. 4 shows schematically a perspective view of an arrangement of transport frames on a containment structure base mat of a nuclear plant. More particularly, three steam generator transport frames 154 sit on top of respective cavities formed in the base mat 160. In use, respective steam generators are mounted in the transport frames and coolant pumps for the steam generators locate in the cavities. A further transport frame 158 for a pressuriser is located adjacent the steam generator transport frames. Further cavities are formed in the base mat for the central RPV, pipework and other nuclear plant equipment. These transport frames 154, 158 facilitate the integration of the plant components with each other, and form a permanent part of the plant. Thus, they enhance the modularity of the parts of the plant. As a result, the time and cost associated with plant construction can be reduced.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A combination of a transport frame and a nuclear plant steam generator mounted in the transport frame, wherein:
the steam generator has an upright elongate body and has tension members extending from proximal ends attaching to respective attachment positions on the elongate body to distal ends which are configured to attach to respective load-supporting attachment positions in the nuclear plant, each proximal end being lower than its respective distal end whereby, in use, the tension members are loaded in tension by the steam generator to transmit substantially all of a weight of the steam generator to the load-supporting attachment positions in the nuclear plant; and
the transport frame is configured for transporting the steam generator to a site of a nuclear plant, and the distal ends of the tension members attach to respective load-supporting attachment positions in the transport frame, the tension members being loaded in tension by the steam generator to transmit weight of the steam generator to the load-supporting attachment positions.

2. The combination of claim 1, wherein each tension member has articulatable connections at its proximal and distal ends which attach the member to respectively its attachment position on the elongate body and its load-supporting attachment position in the nuclear plant, the articulatable connections being configured to allow the steam generator to move relative to the load-supporting attachment position in the nuclear plant to accommodate lateral movement of the steam generator relative to the nuclear plant or vibration of the steam generator.

3. The combination of claim 2, wherein each articulatable connection is a pin-jointed connection.

4. The combination of claim 1, wherein the tension members are equally angularly spaced in a circumferential row around the elongate body.

5. The combination of claim 4, having four tension members spaced 90° apart.

6. The combination of claim 1 further having a reactor coolant pump suspended beneath the elongate body, the weight of the reactor coolant pump being transmitted to the load-supporting attachment positions in the nuclear plant via the elongate body and the tension members.

7. The combination of claim 1 further having lateral restraints configured to limit or prevent sideways movement of the steam generator.

8. The combination of claim 7, wherein the lateral restraints are located above the tension members.

9. The combination of claim 7, wherein the lateral restraints are equally angularly spaced in a circumferential row around the elongate body.

10. The combination of claim 9, having four lateral restraints spaced 90° apart.

11. (canceled)

12. The combination of claim 1, wherein the transport frame is a steel frame.

13. (canceled)

14. A nuclear plant including the combination of the transport frame and the steam generator of claim 1, the transport frame being a first transport frame and integrating with further transport frames in the nuclear plant to which are mounted other components of the nuclear plant, the first and further transport frames thereby forming a permanent part of the nuclear plant, and the distal ends of the tension members attaching to the respective load-supporting attachment positions of the first transport frame, such that the tension members are loaded in tension by the steam generator to transmit substantially all of the weight of the steam generator to the load-supporting attachment positions of the first transport frame.

15. A method of constructing a nuclear plant, the method comprising:
providing the combination of the transport frame and the steam generator of claim 1;
transporting the combination of the transport frame and the steam generator to the site of a nuclear plant; and
installing the combination of the transport frame and the steam generator in the nuclear plant, the transport frame being a first transport frame and integrating with further transport frames in the nuclear plant to which are mounted other components of the nuclear plant, whereby the first and further transport frames form a permanent part of the nuclear plant, and the distal ends of the tension members attach to the respective load-supporting attachment positions of the first transport frame, such that the tension members are loaded in tension by the steam generator to transmit substantially all of the weight of the steam generator to the load-supporting attachment positions of the first transport frame.
